(19) United States
(12) Patent Application Publication
(10) Pub. No.: US 2008/0151056 A1
(43) Pub. Date: Jun. 26, 2008

(54) Automatic camera with inbuilt smoke and motion detectors that can send picture/pictures with audio or text

(76) Inventor: Chukwu Ahamefula, Houston, TX (US)

Correspondence Address: CHUKWU AHAMEFULA;APT 2114, 9700 COURTGLEN DRIVE, HOUSTON, TX, 77099, US

(21) Appl. No.: 11/642,189

(22) Filed: Dec. 20, 2006

(51) Int. Cl. H04N 5/33; H04M 11/04; H04N 5/228; H04N 5/232; H04N 5/225

(52) U.S. Cl. 348/164; 455/404.2; 348/222.1; 348/211.99; 348/372; 348/220.1; 348/E05.031; 348/E05.042; 348/E05.024; 348/E05.09

(57) ABSTRACT

This invention is more particular to a camera that is fully equip with an inbuilt motion and smoke detector and a digital audio recorder and a vice synthesizer and a text generator, the camera is specially design to be set by the user to capture any emergency condition detected by any of the said inbuilt detectors, and automatically send picture or pictures of the emergency along with an audio speech pre-recorder by the user or a written text pre-enter by the user at the top of the picture or bottom, side or middle of the captured image, the voice synthesizer, or the text generator states the exact emergency which can be fire or intrusion, why the pre-recorder audio or text entered by the user states the address of the emergency both information combined together (the emergency and the address) is sent out by the camera to one or more preset number of a cellular telephone of the user choice, cellular telephone that can receive the picture with the text or the audio by means of any available telecommunication network, the picture sent by the camera can be a still picture or a motion picture and the camera can be a visible light camera or an infrared camera.

### BACKGROUND OF THE INVENTION

### 1. Field of Invention

The present invention relate to a camera security system, and more particular to a network security camera, that is easily pre-set by the user to disclose the exact location of an emergency by sending picture/pictures of the emergency and a pre-recorded audio message or text message with the picture to any pre-set number(s) of a cellular telephone that can receive the picture with the pre-recorded audio message or the text message, the audio or text message that came along with the picture tells the location/address at an advent of the following emergency conditions smoke/fire or intrusion. The camera sends this massages by means of any available telecommunication network, the picture sent by the camera can be a still picture or a motion picture and the camera can be a visible light camera or an infrared camera.

Further more this invention is more particular to a network camera that is fully equip with an inbuilt motion and smoke detector, the camera is specially design to capture any emergency condition detected by any of the said inbuilt detectors, and automatically send picture/pictures of the emergency along with audio or text massage stating the address of the emergency, this information is sent by the camera to one or more pre-set wireless cellular telephone (number) that can receive the picture with the audio signal or the text massage.

### SUMMARY OF THE INVENTION

The present invention is more particular to a security camera that have an inbuilt smoke and motion detector a digital audio recorder and a voice synthesizer and a text generator, the camera have the ability to send pictures of an emergency automatically with a pre-recorded audio signal of the user or some written text massage pre-enter by the user, the text or the audio states the exact location or address of the emergency, the picture(s) and the audio or the text message is sent out along with the emergency generated by the said voice synthesizer or the text is generator at the same time automatically by the camera to any pre-set telecommunication number of a cellular telephone that can receive the said information by means any available telecommunication network. The camera also comes with an external remote control and an external digital video and audio recorder D.V.A.A.R with one or more memory cards. The remote control is specially designed for operating the camera, the remote control act as a transceiver by sending and receiving data (program) to and from the camera. The camera is programmed originally by the manufacturer to disclose emergency condition example, fire or intrusion by sending picture/pictures of the emergency with text message or audio message stating the emergency that can be fire or intrusion, at the top, bottom or side of the emergency picture sent to any receiving cellular telephone. The remote control is specially design for the user for the purpose of operating the camera and for entering the address or location were the camera will be install around the premises, if incase any emergency condition is detected by any of the detectors in the camera, the exact picture(s) of the emergency condition and some text message or audio message stating the emergency generated by a voice synthesizer or the text generator and the pre-recorder audio or text telling the location of the emergency will be automatically sent to any cellular telephone that the communication number that have been pre-set by the user using the remote control, The user originally pre-recorder the audio message telling the address of the camera using some special buttons and a sensitive microphone in the camera, also the user using the remote control originally pre-entered text message telling the location or address of the camera. The programmed or pre-set cellular telephone number can be any preferred emergency responding party e.g. the police cellular telephone number, fire service cellular telephone number, or any other emergency responding party cellular telephone number(s). The user can also pre-set his or her cellular telephone number for self-automatic emergency picture with audio or text sent automatically by the camera when any emergency is detected by any of the said detector and the information is sent by the camera by mean of any available telecommunication network. One or more telecommunication company can server as the automatic camera service provider, because the camera works by connecting to one or more telecommunication network.

The audio statement that tells the address or location of the camera was pre-recorder by the user using some set of buttons connected to a digital audio recorder in the camera and the audio statement can be erase and a new audio statement telling address or location of the camera can be recorded by user using the same set of button, this is in case the user decides to change the location of the camera.

The address or location of the camera pre-entered by the user using some set of buttons in the remote control can be erase and a new address or location of the camera can be enter or key in by the user using some digit or alphabetical buttons in the remote control, this is in case the user decide to change the location of the camera.

The camera also has an inbuilt alarm that can be set to sound when emergency condition is detected by the said inbuilt detectors. The alarm can also be set to sound only when smoke or fire is detected, it can also be put off completely, all this operations can be set by the user using the remote control.

The remote control have some set of buttons label 0 to 9 they are use for entry cellular telephone number, and they are also use for entering alphabets e.g, for entering the address or location of the camera, other functions of the 0 to 9 buttons include password entry and for operating the digital video and audio recorder. The remote control also have a power on/off button, a select button, a shift button and an enter button, play button, stop button, rewind button, forward button with the use of all this set of buttons camera can be program by the user to function in the operation described in the invention.

The remote control displays some programs downloaded by a microcontroller in the remote control, the microcontroller download the programs from the camera, and the programs are displayed on a liquid crystal display in the remote. Here are listed names illustrating the programs; (1) Enter camera location or address, (2) Set intruder alert, (3) Set fire alert, (4) Enter numbers of alerts you want, (5) Set activation or deactivation menu, (6) Alarm on/off menu, (7) Password change menu, (8) Set video recorder, utilizing the key in buttons in the remote control and the program select button, with the enter button, and the shift button, the camera can be programmed by the user to function in the operation describe in this invention. The user can set the camera to report an emergency using the remote control.

The digital video and audio recorder D.V.A.A.R has an inbuilt memory for recording any video and audio signal detected from the camera and an external insert-able memory card. The digital video and audio recorder can be set by the user to automatically start recording when any video and audio signal is capture by the camera, if the inbuilt detectors detect any of the said emergencies. The digital video and audio recorder D.V.A.AR can also be set by the user to record continually or at all conditions any image and audio captured by the camera whether any emergency condition is detected or not.

The memory card are specially design to store video and audio signal detected by the camera, when the camera is connected to the digital video and audio recorder D.V.A.A.R, and the card are inserted into the digital video and audio recorder D.V.A.A.R, the memory card are made up of electronic circuits and they can be inserted or disconnected from the digital video audio recorder D.V.A.A.R by the user. The memory card can store a wide range of hours of video and audio signal and the digital video and audio recorder can be loaded with one or more memory cards. The camera and the digital video and audio recorder are controlled with the same remote control, the play button in the remote control is use to play back any video and audio signal store in the digital audio recorder, the rewind button R is use for rewinding back word the video and audio captured by the camera why the forward button F is use for fast forwarding and image and audio captured by the camera, and pulse button is to pulse still and image detected by the camera, and the stop button for stopping the digital video and audio recorder from playing any video and audio information and the remote control connect to the camera and the digital video and audio recorder by mean of a wire wireless medium and the information recorder by the digital video and audio recorder is sent to TV or computer monitor by wire for monitoring.

For more understanding of the nature and objective of the present invention, reference should be made to the following steps taken in conjunction with the accompanying drawings.

### BRIEF DESCRIPTION OF THE DRAWINGS

1, Step 1 to 15 describes the embodiment of the camera and the digital video recorder and the remote control and the program generated by the camera as downloaded by the remote control and the method of operating the camera to send emergency picture with text message or audio message to any wire or wireless cellular telephone that can receive the picture(s) with any of the said method messaging.

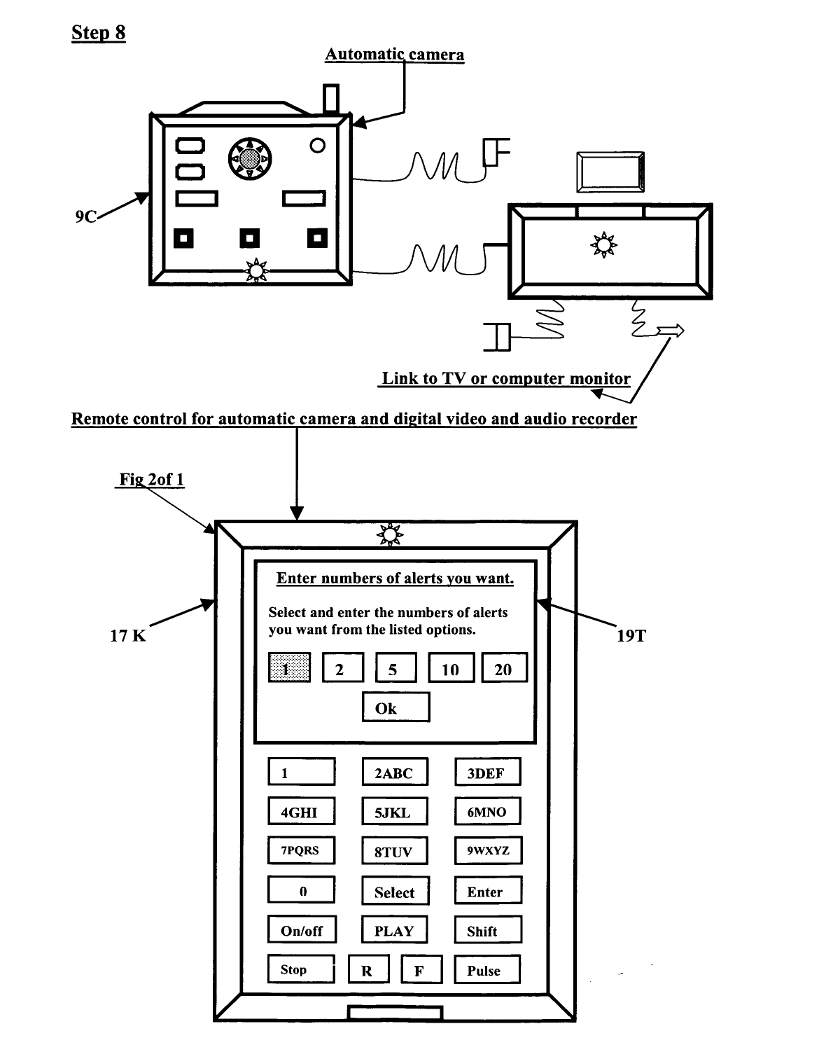

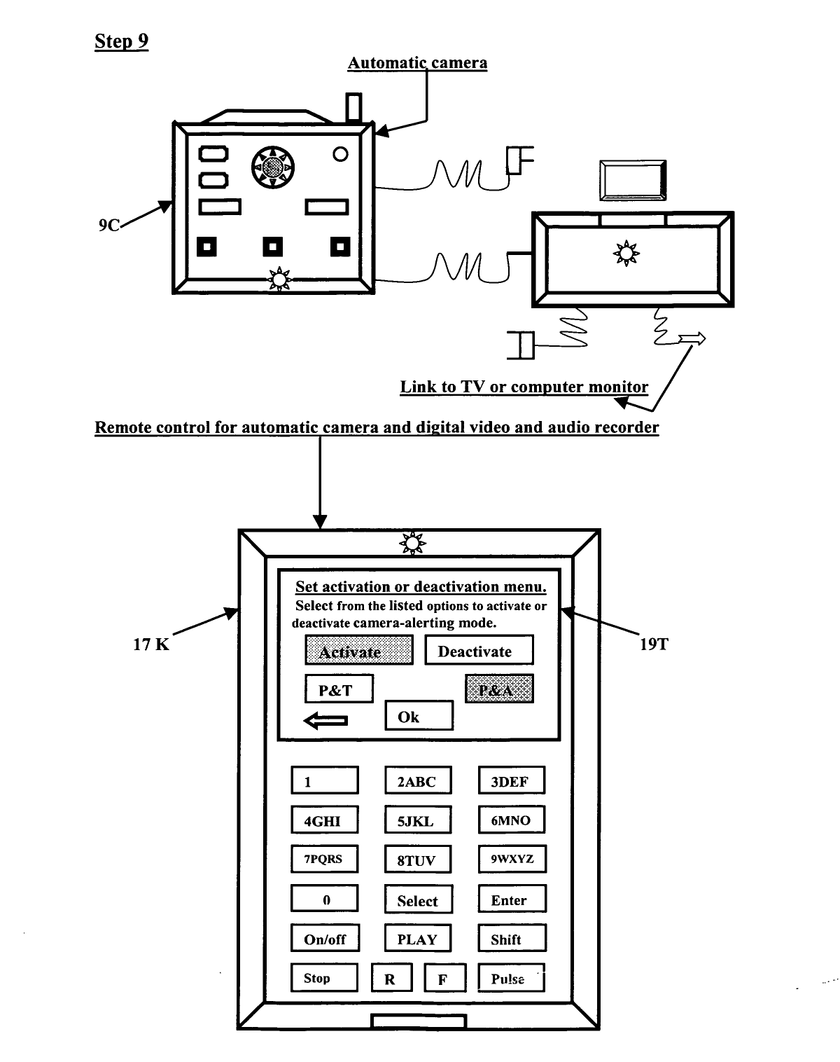

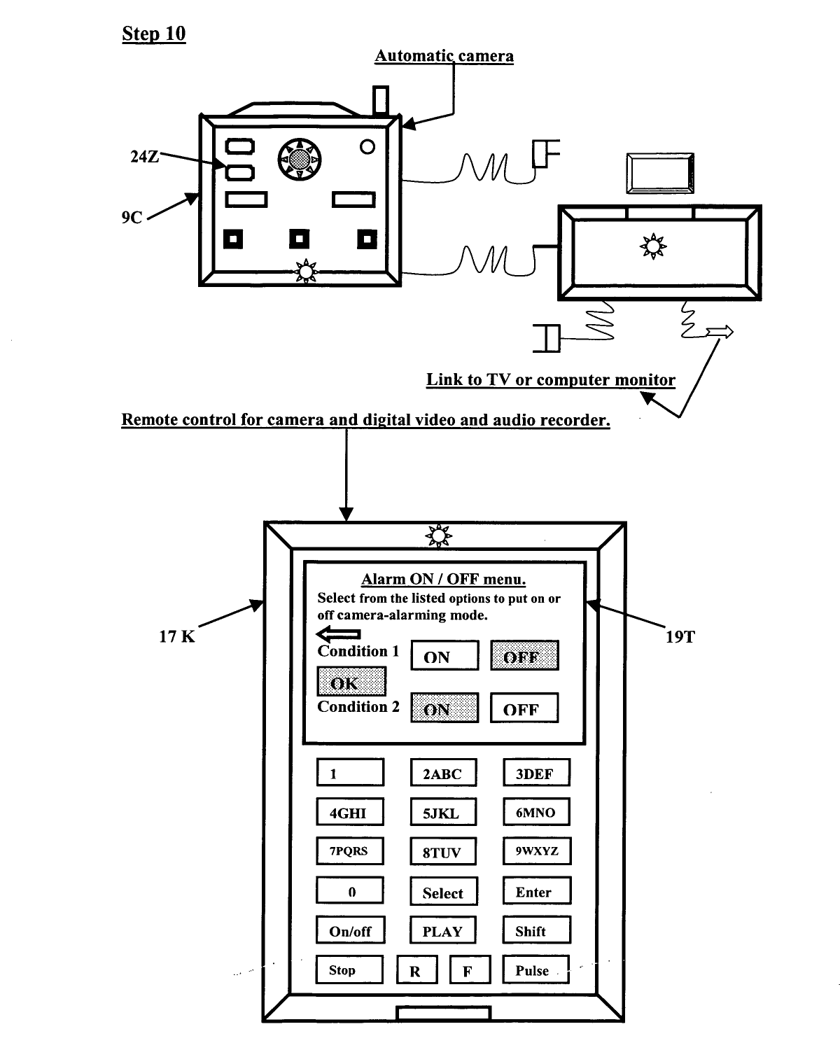

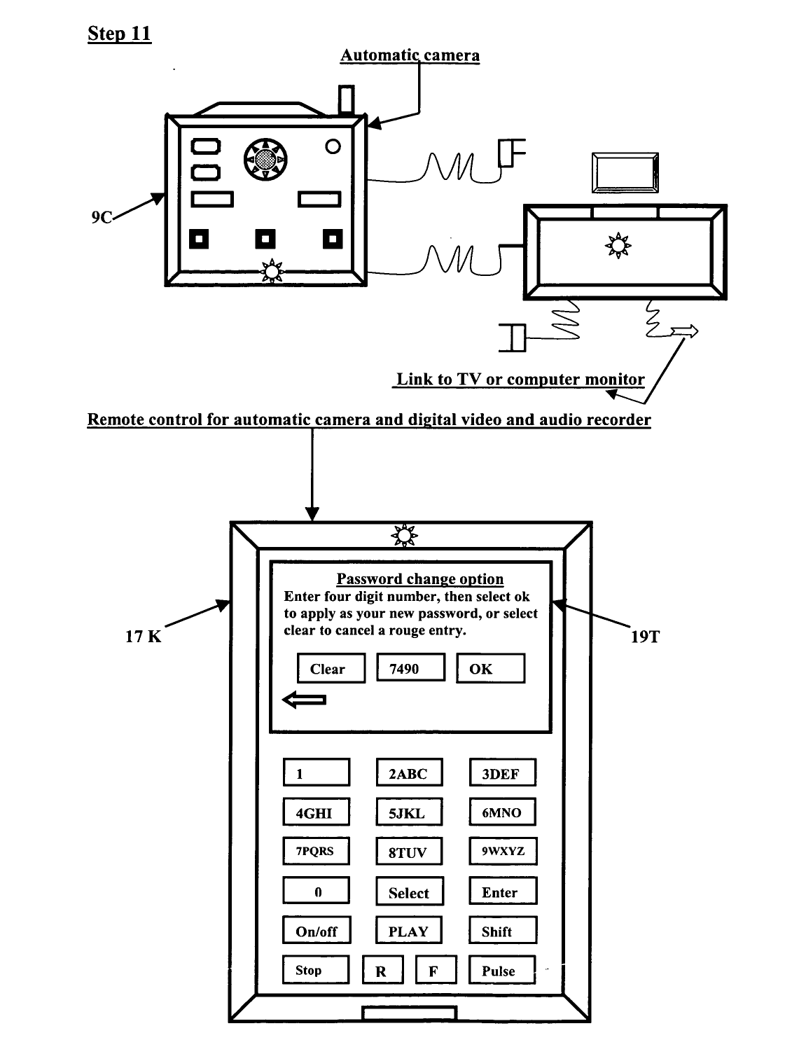

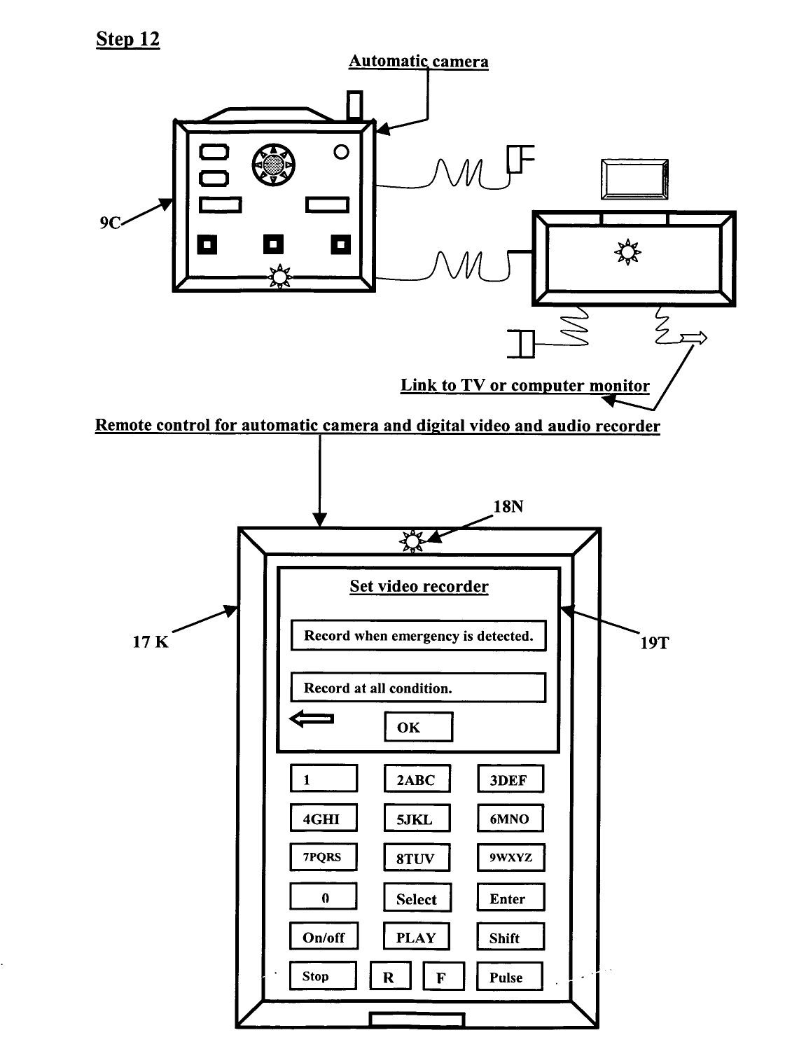

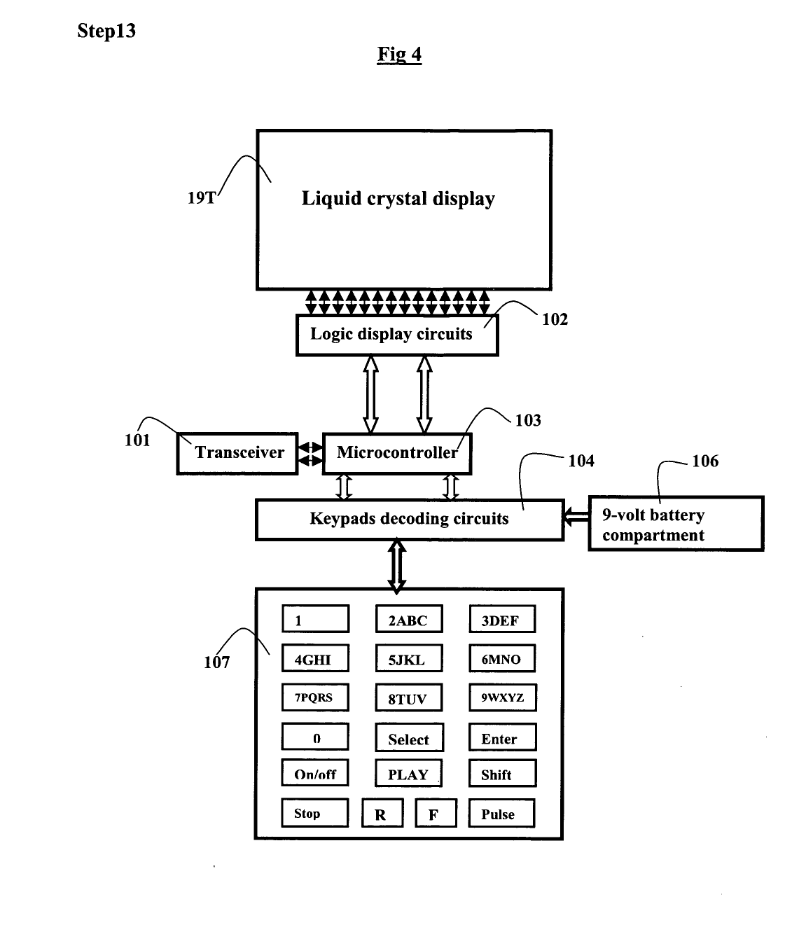

2, Step 13 shows FIG. 4 the electronic block diagram of the remote control.

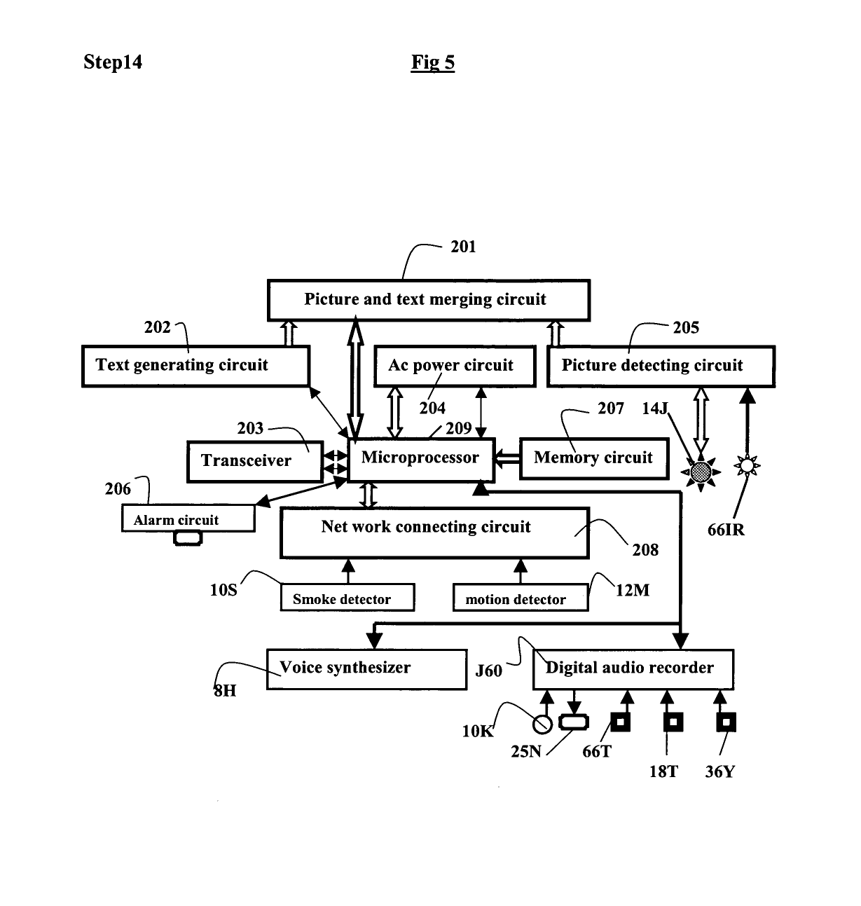

3, Step 14 shows FIG. 5 the electronic block diagram of the automatic camera.

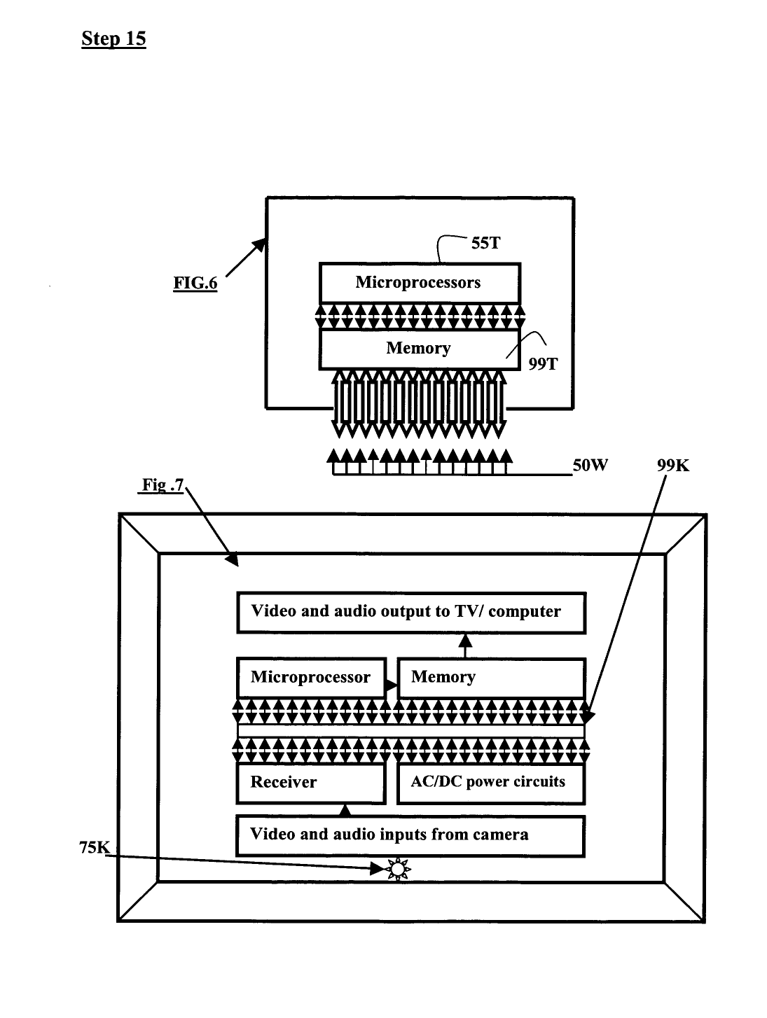

4, Step 15 shows FIG. 6 and FIG. 7, FIG. 6 is the electronic block diagram of the memory card and FIG. 7 the electronic block diagram of the digital video and audio recorder.

### DETAILED DESCRIPTION OF THE PREFERRED EMBODIMENT

Step 1 shows FIG. 1 is the embodiment of the camera 9C and it is a desktop and wall mounted camera 9C with an inbuilt smoke detector 10S and an inbuilt motion detector 12M. The camera 9C comes as a wireless network camera; an AC power supply or a battery can power the camera 9C, here is the camera 9C AC cord 15. FIG. 2 is the embodiment of the remote control 17K, the remote control 17K comes as a wireless remote control and with the following features, some set of key pads located in the lower region of the remote control 17K numbered 0 to 9 also the key pad or buttons are lettered from 2 to 9 with the letter A to Z, other buttons or key pads also located in the lower region of the remote control 17K are, select button, an enter button and a shift button play button, stop button, rewind button and the forward button. The remote control also come with an L, C, D liquid crystal display 19T, the remote control is powered by inserting a 9 volt battery into the battery compartment 20G. The smoke detector 10S in the camera 9C is design to detect any outback of smoke or fire, why the motion detector 12M is design to detect intrusion in the area were the camera 9C was installed and automatically activate an electronic circuit that is made up of one or more microprocessor and some other special electronic component like memory chip, transistors, diode, capacitor and more, all this component in the camera work together to send the picture detected through a lens 14J in the camera 9C to any pre-set wire/wireless cellular telephone (number) automatically.

The set of keypads labeled 0 to 9 and A to Z in the remote control is use for entering cellular telephone number or numbers, the key pads is also use for entering password for operation the camera, further more the key in buttons or key pads is use for entering alphabet or alphabets, example of the alphabet enter is the address or location were the camera 9C is installed, the key in button or key pads are touch tone pads or buttons. The select button located in the lower region in the remote control 17K is use for selecting programs displayed on a liquid crystal 19T in the remote 17K, a selected option are automatically highlighted and it is automatically stored or finally selected or enter with the use of the enter button or key pads. The Shift space bar button or keypad is use for making space between alphabets, when the user enters alphabets or letters e.g. the address/location of the camera 9C. All information selected and enters by the user using the remote control 17K, are automatically sent to the camera 9C, because the remote control 17K works as a transceiver and the remote control 17K can work as a master remote control 17K because it can operate one or more automatic camera 9C.

The remote control 17K displays some program or menu this program or menu are use in controlling the camera 9C and the digital video and audio recorder, and they are elaborated from step 1 to 15, step 1 show FIG. 1 the embodiment of the camera the camera 9C comes with an inbuilt motion detectors 12M and smoke detector 10S mounted in the housing of the camera 9C. Also in step 1 the remote control FIG. 2 17K displays some text instruction and some option named clear and ok in a liquid crystal 19T, the text is instructing the user what to do as soon as the on/off button located at the lower end of the remote is activated to turn on the remote, the liquid crystal 19T in the remote control 17K displays set operation menu in this menu the user is welcome and instructed to enter password to continue set operation menu, the password is a four digit password that was set by the user or the manufacturer if the rough password is enter by the user using the key in buttons or key pads and the ok option is selected using the select and enter buttons the remote control automatically displays step 2.

Reference is made to step 2 in continuation of step 1 the liquid crystal 19T in the remote control 17K displays another instruction in step 2 telling the user Sorry the password you have entered did not correspond with available data, please try again. This said date is the password encoded to unlock the operating menu downloaded by the remote control 17K from the camera. If the user enters the right password and the ok option displayed on the liquid crystal is selected using the select and enter buttons the remote control 17K automatically displays step 3.

Reference is made to step 3 in continuation of step 2 the liquid crystal 19T in the remote control 17K displays another instruction in step 2 telling the user thank you, remote control 17K is downloading set operation menu from automatic camera 9C, please wait. And two dark bars will appear in the liquid crystal 19T, when the two dark bars becomes equal the remote control automatically displays step 4, it only take a few seconds for the two dark bars to become equal indicating a complete download of the operation menu from the camera control 9C.

Reference is made to step 4 in continuation of step 3 the liquid crystal 19T in the remote control 17K displays another instruction in step 4 telling the user welcome to set operation menu select from these options to program camera 9C. In this menu a list of option is displayed on the liquid crystal 19T in the remote control 17K and the user is instructed to select from the option or programs listed, here are the names illustrating the programs in step 4, (1) Enter camera location or address. (2) Set intruder alert. (3) Set fire alert. (4) Enter number's of alerts you want. (5) Set activation or deactivation menu. (6) Alarm on/off menu. (7) Password change menu (8) set video recorder. This option or programs are selected by the user to set or operate the camera 9C using the select and enter button in the remote control 17K, the remote control 17K work as a transceiver by sending and receiving information to and from the camera 9C. This programs and options is described one after another from step 5 to step 12.

Reference is made to step 5 in continuation to step 4 the liquid crystal 19T in the remote control 17K displays another instruction in step 5 and it is the eternal view of menu or program number (1), the instruction in program number (1) tells the user to enter camera 9C location or address. With the use of the key in buttons or key pads labeled A to Z and the select and enter buttons the user can enter the exact location were the camera 9C will be installed which can be his or her home address or office, or room, and with the shift Space bar button located also in the lower region of the remote control 17K the user can space or shift letters or alphabets entered in other for the letters to make sense to a reader. After the user have finished entering the location or address of the camera 9C, the user should select store in other for the remote control 17K to send the location or address to the camera 9C for storage, if the user decide to change the location of the camera 9C the user can select clear from the option display on the liquid crystal 19T and re-enter a new location or address using the key pads in the remote control 17K, the address or location of the camera 9C entered by the user is display on the liquid crystal before it is sent to the camera 9C for storage. An arrow indicating left is also displayed in the liquid crystal 19T in the remote control 17K the arrow can be selected and enter at any of the steps by the user if the user decides to go back to step 4, using the select and enter button in the remote 17K the user can select the arrow.

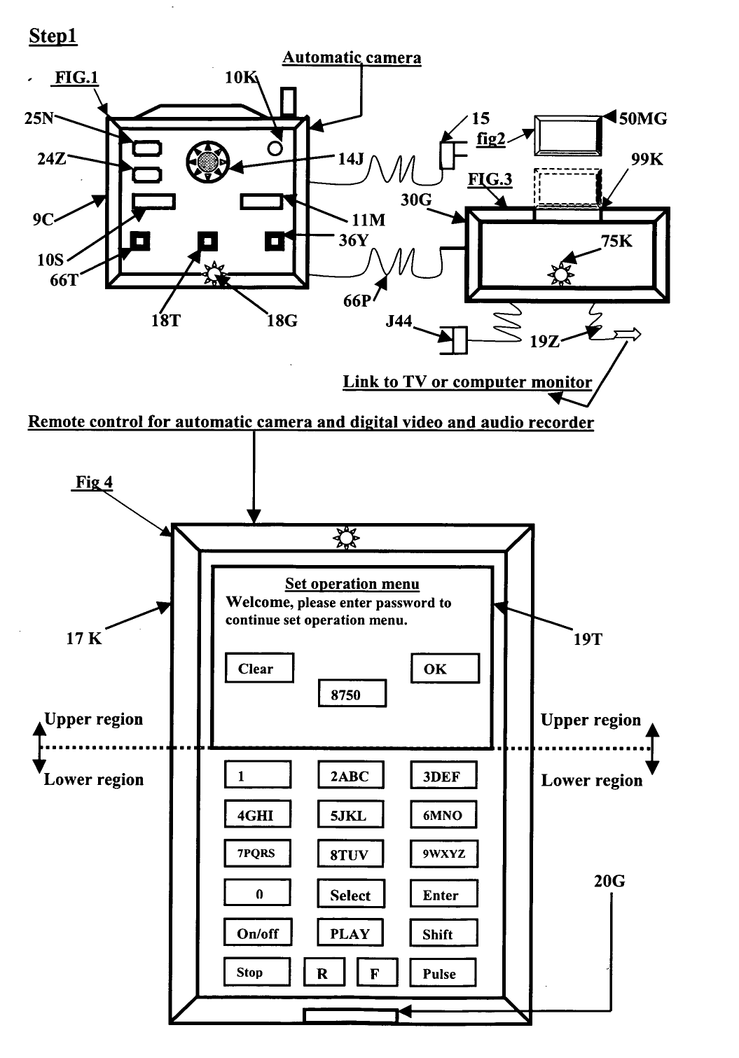

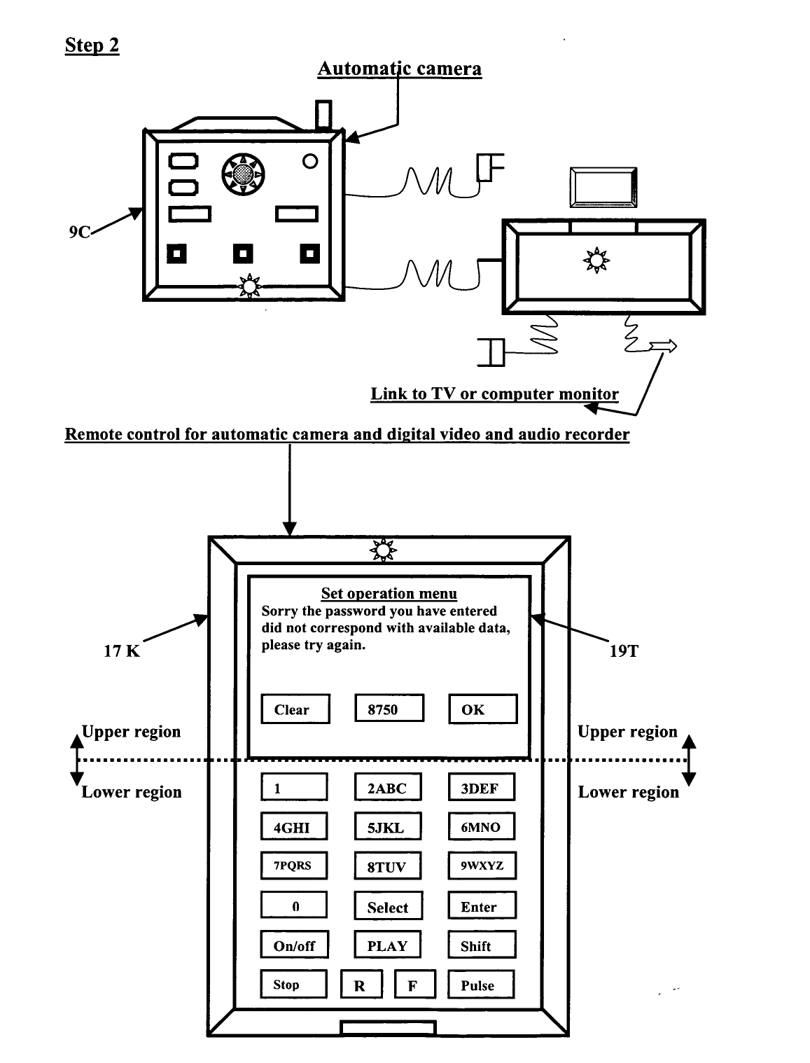

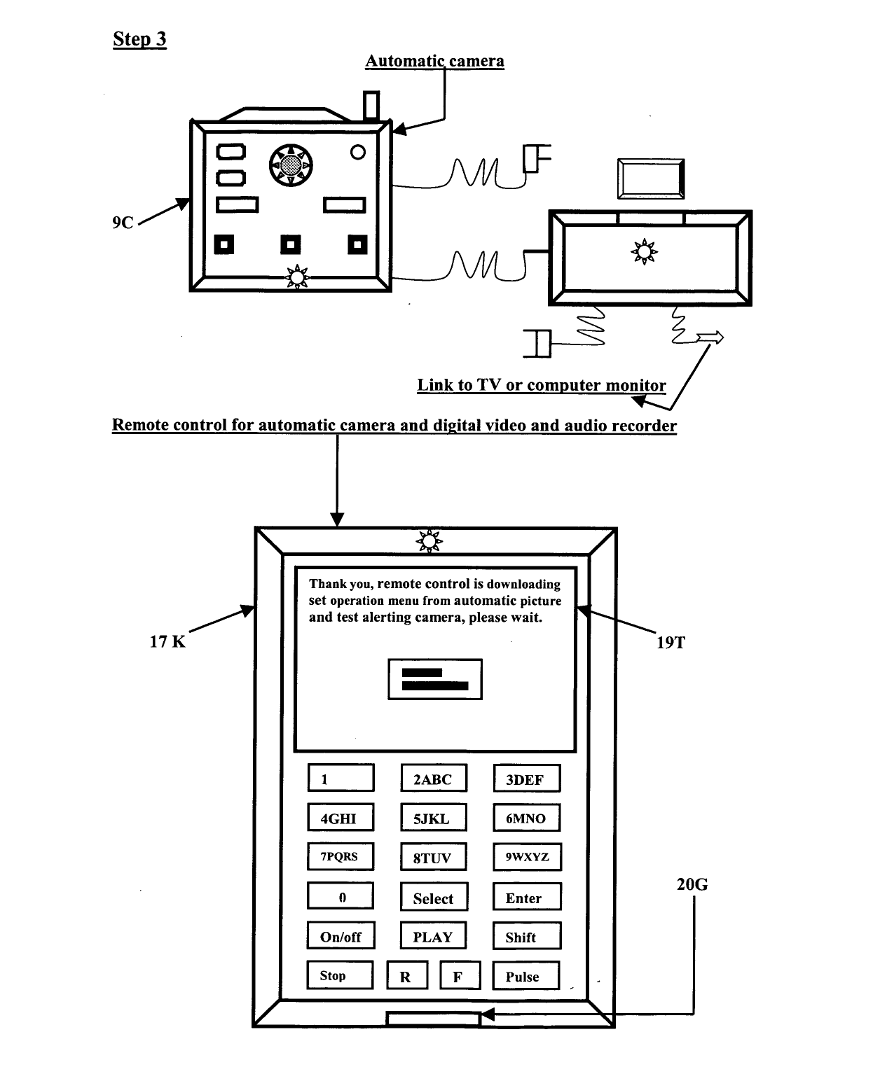

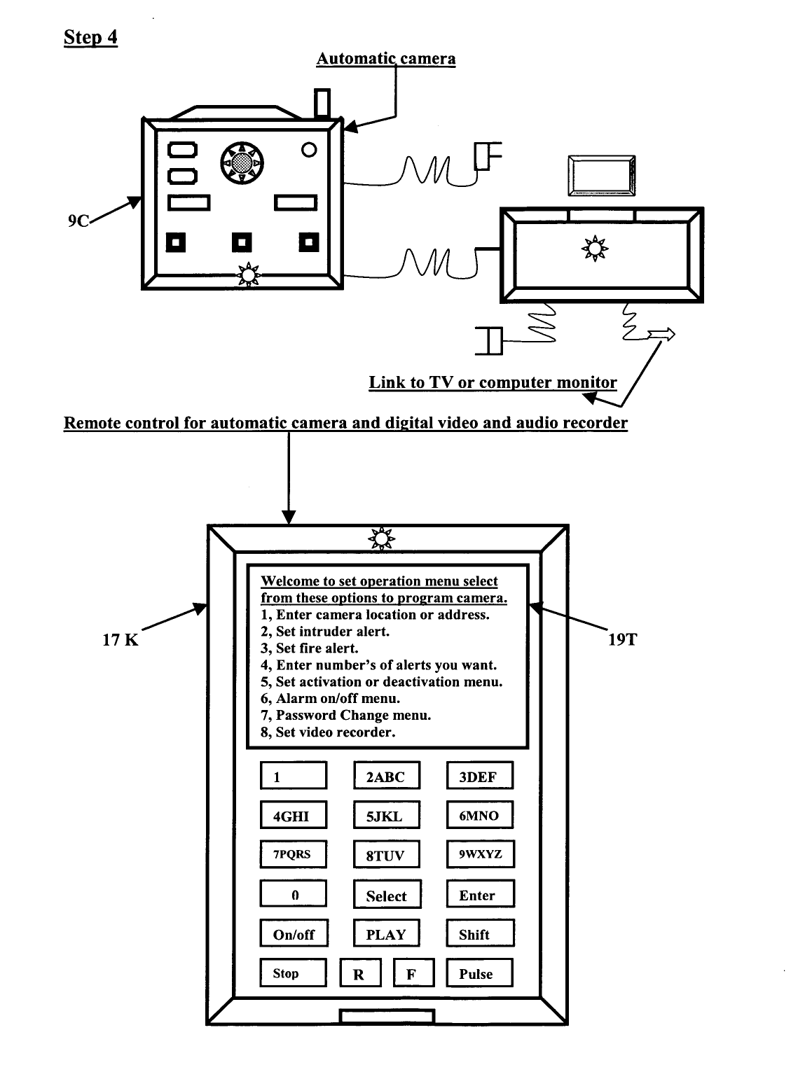

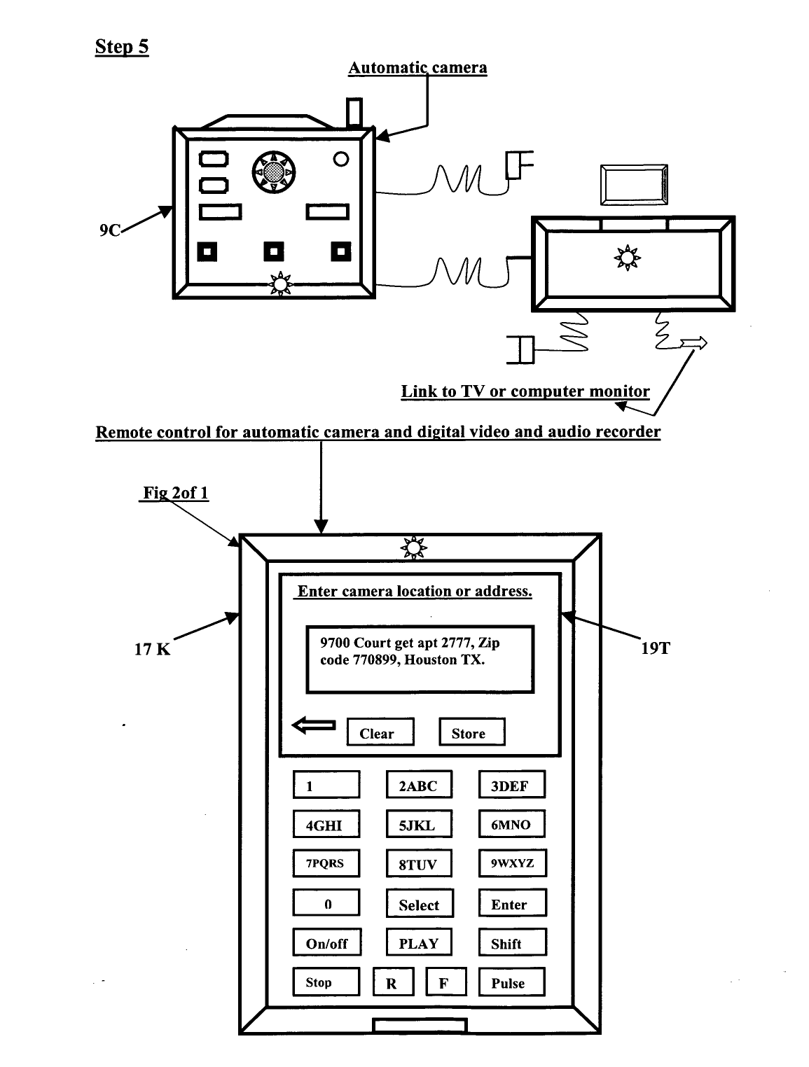

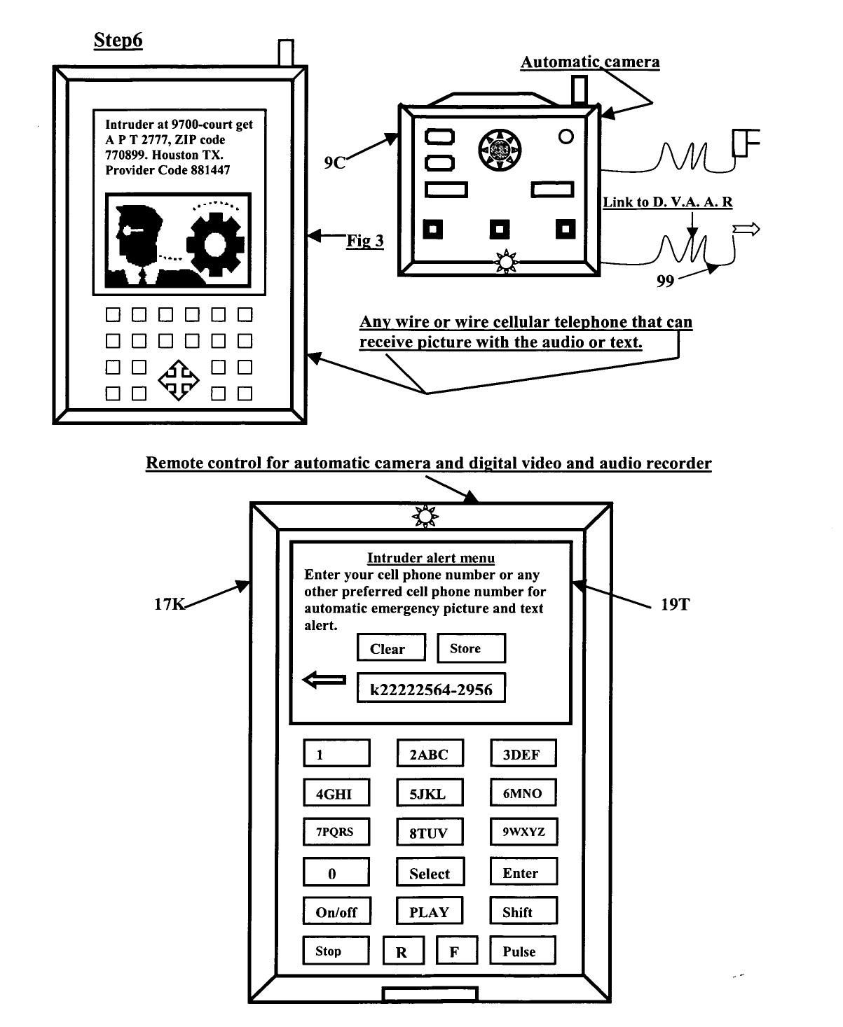

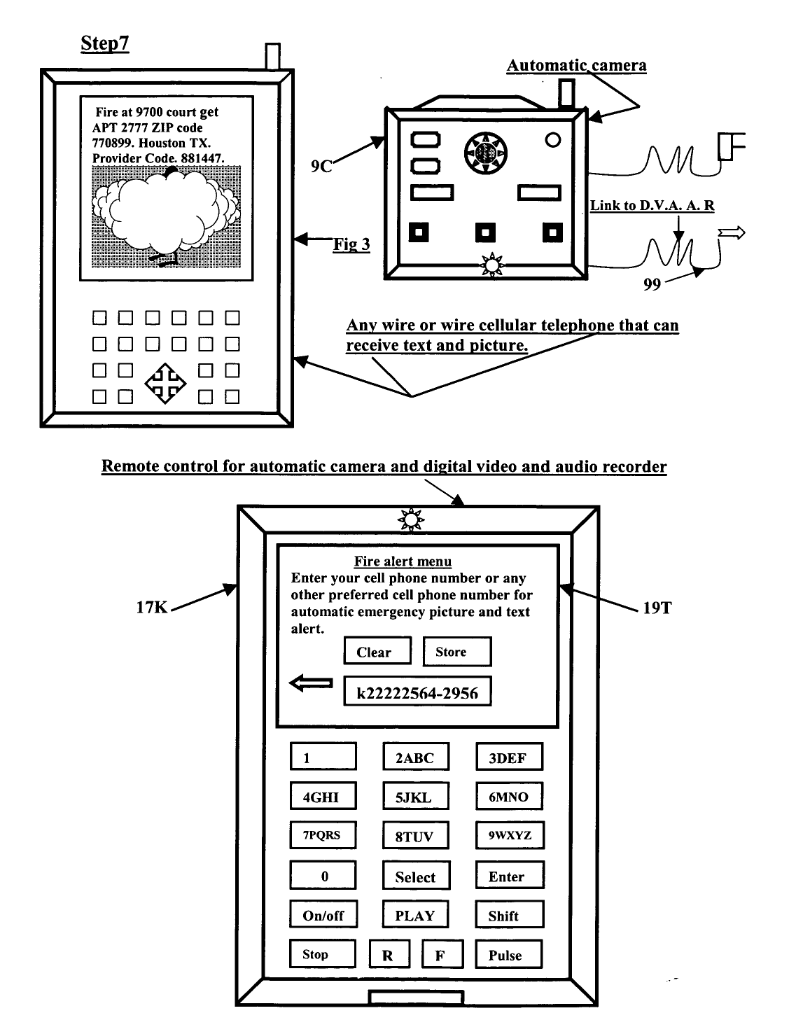

Reference is made to step 6 in continuation of step 4 the liquid crystal 19T in the remote control 17K displays another instruction in step 6 and it is the eternal view of menu or program number (6), the menu or program displayed say enter number for intruder alert, and also an instruction is displayed in program number (6) telling the user to enter his or her cell phone number or any other preferred cellular telephone number for automatic emergency picture with text or audio alert, the user can enter his or her cellular telephone number or any other party e.g. the police or any other party the user want the automatic camera 9C to send picture of intrusion that comes along with the text message or the pre-recorder audio telling the address of the camera 9C when any emergency is detected by the motion detector in the camera 9C, this only happens when the camera 9C is set by the user to alert by sending the picture with the audio or text telling the address or location of the camera 9C which is also the address of the emergency. FIG. 3 show example of any wireless cellular telephone that can receiver the picture with the text or audio and how the picture of the intruder and the text message telling the location or address of the emergency sent by camera 9C may appear in the cellular telephone, apart from the text telling emergency generated text and the alphabets pre-enter by the user telling the exact location of the emergency some numbers are automatically displays along with the text message that comes along with the picture the numbers are called the provider code or number. Example of the provider code is displayed 881447 in the alerted cellular telephone; the code is use by any alerted party like the police or fire service, when any false alert is sent by any user, false alert include rough address or false emergency alert. All the police or the fire service or any other emergency party need to do is to send the provider code to the provider and the provider will use the provider code or number to fish out the owner of the alerted camera 9C, the provider code appear weather the camera 9C is set to alert when fire or intrusion is detected by the motion detector 10S and the smoke detector 12M in camera 9C. Another way the own of the camera 9C can be identify can be in form of caller id or net work number just like a telephone number, that can be equally be sent by the camera to the alerted cellular telephone.

Reference is made to step 7 in continuation of step 4 the liquid crystal 19T in the remote control 17K displays another instruction in step 7 and it is the eternal view of menu or program number (7), the menu or program displayed, say enter number for fire alert, and also an instruction is displayed in program number (7) telling the user to enter his or her cellular telephone number or any other preferred cellular telephone number for automatic emergency picture with text or audio alert, the user can enter his or her cellular telephone number or any other party e.g. the fire service or any other party the user want the automatic camera 9C to send picture of outbreak of fire and the text or audio message telling the address of the camera when emergency is detected by the smoke detector 10S in the camera 9C, this only happens when the camera 9C is set by the user to alert by sending the picture with the text telling emergency to any wireless cellular telephone that can receiver the picture with the text or audio, and how the picture of the fire and the text message telling the location or address of the emergency sent by the camera 9C may appear in the cellular telephone.

Reference is made to step 8 in continuation of step 4 the liquid crystal 19T in the remote control 17K displays another instruction in step 8 and it is the eternal view of menu or program number (8), the menu or program displayed, says enter numbers of alerts you want, in the is menu the users is instructed to select and enter the numbers of alerts he or she want from the listed options number of alerts means the number of times the camera can send the picture of an emergency automatically to one or more wireless cellular telephone, with the use of the select and enter button the user can select from the number of times he or she want the automatic camera 9C to automatically send picture with text or audio when any emergency is detected by any of the detectors, some numbers are also displayed in the liquid crystal 17K in the remote control 9C they are 1, 2, 5, 10, 20, a selected number is automatically highlighted and the user should select ok using the select and the enter button in other to set or store the number of alerts selected, if the user want unlimited alert the user can contact the provider because the camera can also be set by the provider from the provides station to alert at any number of times.

Reference is made to step 9 in continuation of step 4 the liquid crystal 19T in the remote control 17K displays another instruction in step 9 and it is the eternal view of menu or program number (9), the menu or program displayed are set activation or deactivation menu, in the menu the user is instructed to select from the listed options to activate or deactivate the camera 9C alerting mode, with this menu the user can activate or deactivate the camera 9C alerting mode when exiting or entering the premises were the camera 9C is located with the use of the select and enter button the user can select from the options display in the liquid crystal 19T and enter to apply a particular option, the ok is selected and entered with the use of the select and enter button in the remote control 17K, the activate option if selected by the user enable the camera 9C to send picture with text or audio to any pre-set cellular telephone number entered by the user why the deactivate option disable the camera 9C from sending picture with audio or text when any said emergency is detected in the premises were the camera 9C is located, another option is also displayed in step 9 the P&T and the P&A, the P&T if select by the user the camera only send picture displayed with text to any wireless cellular telephone when any emergency is detected by the said detectors and if the P&A is selected the camera will only send picture with audio.

Reference is made to step 10 in continuation of step 4 the liquid crystal 19T in the remote control 17K displays another instruction in step 10 and it is the eternal view of menu or program number (10), the menu or program displayed are alarm on/off menu, in the menu the user is instructed to select from the listed options to put on or off camera 9C alarming mode. With the use of this menu, the user can set the alarm 24Z in the camera to sound or not to sound when any emergency is detected by selecting from the options displayed in the liquid crystal 19T condition 1 and condition 2 enable the alarm 24Z to sound or not to sound when the camera 9C is set or not set to send picture with text. The options in condition 1 and 2 are on or off and are selected by the user using the select button in the remote control 17K and the selected options is applied by the camera when the user select ok.

Reference is made to step 11, and is in continuation of step 4 the liquid crystal 19T in the remote control 17K displays another instruction in step 11 and it is the eternal view of menu or program number (7), the menu or program displayed are password change option, in the menu the user is instructed to enter four digit number, then select ok to apply as your new password, or select clear to cancel a rouge entry, the user only make use of this menu if he or she decide to create a new password for operating the camera 9C. When the user have finish entering any four digit pass word the user should select ok to apply the new password as operation menu password, if the user decide to cancel his or her entering the user can select clear to delete or cancel a rough entering.

Reference is made to step 12, and is in continuation of step 4 the liquid crystal 19T in the remote control 17K displays another instruction in step 10 and it is the eternal view of menu or program number (8), the menu or program displayed are set video recorder in this menu the user using the remote control 17K can program or set the digital video and audio recorder to record when emergency is detected only or to record at all conditions by selecting from the listed options.

All options selected and enter in the remote 17K control is automatically sent to the camera 9C by and an infra-red emitter and receiver in the remote control 17K, the remote control 17K comes as a wireless electromagnet-tic or infrared remote control and work with-in 100 meter or more from the area were the camera 9C is located and the remote control can be made to operate in one or more radio frequency or spectrums.

Reference to step 13 shows FIG. 4 the electronic block diagram of the remote control. Here is the key pads 107 the key pads are link to the keypads decoding circuits 104, the keypads decoding circuits 104 function to detect any number or alphabet enter by the user using the keypads 107, the keypads decoding circuit 104 is made up of one or more logic gate or integrated circuit. The keypads decoding circuits 104 are connected to a microcontroller 103, the microcontroller 103 functions in controlling the logic display circuits 102 and the transceiver 101. The logic display circuits 102 function in decoding any program number or text generated or downloaded by the microcontroller 103. The microcontroller also download and sent data to and from the automatic camera by connecting to the transceiver 102 circuit, information generated and downloaded by the microcontroller 103 is displayed on the liquid crystal by the help of the logic display circuit 102. All this segments function together to make the remote control work, the remote control start functions, when a 9-volt battery is connected to the battery compartment in the remote control.

Reference to step 14, FIG. 5 is the electronic block diagram of the camera, here is the smoke detector 10S and the motion detector 12M in the camera the motion detector 12M in the camera is an infrared motion detector, the smoke and motion detectors are design with sensors. The transceiver 203 plays an important roll by sending and receiving data from the remote control. The address or location of the camera, enter by the user using the key pads in the remote control, is receiver by the transceiver 203, and it is processes by the microprocessor 209, and store by the memory 207. When any emergency is detected by smoke detector 10S or motion detector 12M the network connecting circuit will automatically be trigger by the microprocessor, and at the same time the microprocessor also trigger the Picture detecting circuit, and the picture detecting circuit automatically process any picture captured by the lens 14J in the camera. The picture detecting circuit 205 also starts preparing the picture to be sent to one or more program cellular telephone number programmed by the user using the remote control. Moreover, at the same time, the picture detecting circuit is preparing to send the picture; the text generating circuit 202 automatically starts regenerating the address or location of the camera store in memory 207. The address or location was entering by the user using the remote control 207, and text telling the location or address is retrieved from the memory 207 by the text generating circuit 202, additional information not enter by the user but by the manufacture is also retrieve from the memory the text telling emergency depending on the emergency condition that is detected. The picture and the text messages is automatically sent to the picture and text merging circuit 201, the picture and the text will be merge by the picture and text merging circuit 201 and both the text and the picture, will be sent to the network connecting circuit 208. In addition, the net work connecting circuit will automatically send out the picture with the text, by means of any available telecommunication net work or provider, to be received by any program cellular telephone (number) that can receive the emergency picture merging with text message, all the functions occurs in less then 10 seconds or more. Here is the digital audio recorder J60 the digital audio recorder J60 is for recording signal example the audio telling the location of the emergency the sound is collected by a sensitive microphone 10K, a record button 36Y in the camera enables to record audio, and with the erase button 18T the user can erase any audio signal pre-recorded and with the play button 66T the user can play any audio recorded and the sound come out in a speaker 25N in the camera. Here is the alarm; the alarm can be made to generate one on more alarming tones, the alarm can be built with transistors or an integrated circuit, the camera can be built with surface mount or thru hole integrated circuits and other special component such as resistor, transistors, light emitting diode, capacitor, diode and more and star working when the AC power circuit 204 is connected to AC power supply, the camera also have an infrared sensor 661R that receive signal from the remote control.

Reference to step 15, FIG. 6 is the electronic block diagram of the memory card, the memory card can be built with a one or more microprocessor and one or more integrated circuits here is the microprocessor 55T and the memory chip 99T, and FIG. 7 is the electronic block diagram of the digital video and audio recorder, the digital video and audio recorder made up of microprocessor that function store video and audio that was captured by the camera, the microprocessor also function in retrieving or regenerate any video and audio signal that was stored in the memory card or in an inbuilt memory in the digital and recorder, the inbuilt memory in the digital video and audio also function for the purpose of storing video and audio signal other circuits included are ac and dc power circuits and a receiver circuit that function to receive code or command sent by the remote control the code or command is receiver by an infrared censor 75k in the digital video and audio recorder, the digital video and audio recorder have one or more socket 99K for the purpose of inserting of one or more memory card, the digital video and audio recorder also have video and audio input and output the input is for any image or audio detected by the camera and the output is any audio and video regenerated by the camera.

Many more modification will be made to this present invention for any other further features in this invention is analyze from step 1 through 15.

1. I claim a network camera that is easily pre-set by the user to disclose the exact emergency condition and the location of the emergency by sending picture or pictures of the emergency with audio or text message displayed automatically to any cellular receiving picture, text and audio telephone of the user choice.

2. The camera instrument of claim wherein said is fully equip with an inbuilt motion and smoke detector, the camera is specially design to capture any emergency condition detected by any of the said inbuilt detectors and automatically send the picture of the emergency along with audio or some text displayed with the picture stating the address of the emergency, this information is sent by the camera to one or more pre-set telecommunication number of a wire or wireless cellular telephone that can receive the picture and the text massage.

3. The camera instrument of claim also comes with an external remote control, the remote control is specially design for operating the camera and the digital video and audio recorder.

4. The remote control of claim has some set of buttons use for entering number or alphabets.

5. The remote control of claim is use for activating or deactivating the camera.

6. The camera instrument of claim is a wireless camera.

7. The remote control of claim is a wireless remote control

8. The camera instrument of claim has an alarm that can be set to sound when the camera is set to send picture with text message of an emergency to any program cellular telephone number, the alarm can also be set to sound when the camera is not set to send picture with text, the alarm can also be put off completely.

9. The camera instrument of claim can be set to alert by sending picture with text one or more times.

10. The camera instrument has means the user can enter alphabetical letters telling the location or address of the camera using the remote control.

11. The camera instrument of claim can be battery powered or an AC powered

12. The remote control of claim is a battery-powered remote control.

13. The remote control of claim has some set of buttons therein said are use for selecting or entering programs displayed on a liquid crystal in the remote control.

14. The picture sent by the said camera can be a motion or a still picture.

15. The camera instrument of claim can be an infrared or a visible light camera.

16. I claim a digital video and audio recorder that is connect to the camera by wire or wireless means and that can be set by the user to start recording video and audio signal when an emergency is detected by the camera

17. The digital audio recorder of claim can also be set by the user to record continually even if an emergency is not detected.

18. The camera instrument of claim can be pre-set to send picture with text or audio automatically when any emergency is detected.

19. The digital video and audio recorder of claim can be connected to more cameras.
